(19) United States
(12) Patent Application Publication
(10) Pub. No.: US 2014/0186818 A1
(43) Pub. Date: Jul. 3, 2014

(54) COMPUTER BASED SYSTEM AND METHOD FOR ASSISTING AN INTERVIEWEE IN REMEMBERING AND RECOUNTING INFORMATION ABOUT A PRIOR EVENT USING A COGNITIVE INTERVIEW AND NATURAL LANGUAGE PROCESSING

(71) Applicant: Gondy Leroy, Escondido, CA (US)

(72) Inventor: Gondy Leroy, Escondido, CA (US)

(21) Appl. No.: 14/133,145

(22) Filed: Dec. 18, 2013

Related U.S. Application Data
(63) Continuation of application No. 12/794,127, filed on Jun. 4, 2010, now abandoned.
(60) Provisional application No. 61/267,979, filed on Dec. 9, 2009.

(51) Int. Cl. G06F 17/27

(52) U.S. Cl. CPC G06F 17/27
USPC 434/362

(57) ABSTRACT

A computer based system and method for assisting an interviewee in remembering and recounting information about a prior event that occurred using a cognitive interview and natural language processing.

### CROSS-REFERENCE TO RELATED APPLICATION

This application is a continuation of U.S. patent application Ser. No. 12/794,127, filed on Jun. 4, 2010, which claims priority to and the benefit of U.S. Provisional Application No. 61/267,979, filed on Dec. 9, 2009, in the United States Patent and Trademark Office, the entire content of which are incorporated herein by reference.

### FIELD

The field of this invention relates to interviewing and retrieving information from persons by engaging them in a dialog using a computer or other computing device. More particularly, the present invention is a system for assisting an interviewee in remembering and recounting information about a prior event using a cognitive interview and natural language processing.

### BACKGROUND

There are many systems where computers and people interact and that have as their goal the exchange of information. These systems can be divided into two categories. The first category consists of those systems where the computer, or another appropriate device, possesses the information. The interviewee uses an interface to a computer to gain that information. Search engines, such as Google®, are an example of such a system: people submit keywords and expect documents with information in return. Digital libraries are a similar example. How people interact with these systems varies. Some systems have natural language processing components, such as, for example, when questioning an airline reservations system, such as the system described in U.S. Pat. No. 7,558,731, where people can ask questions over the phone. Other such systems are used in an educational context and aim to provide answers to questions as part of the teaching of a specific topic, such as described in U.S. Pat. No. 6,865,370, or as part of an intelligent tutoring system.

The second category consists of systems where the interviewee possesses the information and the system aims to gain and store that information. Most of the current systems in this category are focused on education, such as, for example, standardized testing, and using adaptive questioning to measure a person's knowledge and compare it to a standard. The current systems are based on a predefined, existing body of knowledge. That is, the information is known by the interviewer in advance, such as, for example, the information contained in a textbook or required by a standard test. The aim of these systems is to compare the knowledge of the interviewee with this body of knowledge. Many such applications have a predefined set of questions, such as, for example, to teach languages such as Rosetta Stone® language-learning software. Other systems use automated testing where the questions are based on previous answers, such as described in U.S. Pat. No. 7,513,775. One example is where questions with multiple choice answers are provided and the answer options are adjusted or optimized. In both cases, answers are compared against a known body of knowledge.

Disadvantageously, the two systems described can only work with what the interviewee already knows in advance. There is no meaningful way to extract information that can be more useful than what the user initially enters into these systems.

Existing interview methods belong to one of three types. The first consists of the most common interview, which requires in-person interaction such as, for example, a cognitive interview. The second interview method consists of non-interactive questionnaires or surveys to gather information, such as, for example, a paper-based version of the cognitive interview. Finally, the third interview method consists of online surveys that ask for opinions with a predefined list of questions. In the third method, specific questions are asked that can be answered by checking buttons or boxes. Longer answers can be typed in a text box. However, there is no interaction with a survey taker based on the content of those answers.

The in-person interview method suffers from several problems. It requires an interviewer with good interview skills and training. It is, for example, very difficult, to ask non-leading questions in an interview. Second, a human interviewer will bring his or her perspective to the interview process that can influence the information collected. Even with training, the performance between interviewers varies based on their personal characteristics and skills, because an interviewer can have a bad day or because the interaction with the interviewee can be strained or unwelcome. Third, conducting a good interview takes a significant amount of time by the interviewer during which the interviewer cannot perform other tasks. It also requires specific resources, such as a quiet, private place, which cannot always be available. Furthermore, the interviewee may not feel comfortable talking to the interviewer. Also, gender, race, profession, and age can play a role in the human-to-human interaction leading to erroneous results. Factors often ignored such as personal style, annoying habits, such as, for example, looks and smells, also affect the interview. Finally, additional hindrances to the in-person interview method include: the need to be geographically close or to have sufficient technology resources to interview in a different location, such as, for example, at the place of an accident.

A cognitive interview is a superior technique to the commonly conducted in-person interviews. It uses principles of cognitive psychology to help the interviewee form a mental image of an event that has happened. Additionally, the cognitive interview has a set of principles to guide how and when specific interview questions can be asked. For example, in the cognitive interview, the amount of switching between mental images will be reduced for maximum recall. Although the technique does not address all of the disadvantages mentioned above, the interview style itself is superior and results in a greater amount of quality information obtained during the interview. Many law enforcement agencies are training personnel to use the cognitive interview technique with willing witnesses. The method prescribes how to engage and how to ask questions to assist the interviewee in remembering as many details as possible of a particular event. The cognitive interview has been evaluated in several research studies, in the context of crime reporting by witnesses and victims, and has been shown that more information is recalled compared to using the standard law enforcement interview methods. It is noteworthy that this increase in information does not lead to more inconsistencies or errors.

Although the cognitive interview is very successful when conducted by a well-trained interviewer, there are shortcomings due to both the interviewer's skills and the interviewee's willingness and ability to report. The interviewer needs to be trained to conduct the cognitive interview. Also, the interviewer needs to learn how to empathize and put the interviewee at ease, how to guide the interviewee to the right state of mind to facilitate retrieval of information from memory, how to phrase and order the interview questions, how to frame different types of questions, how to avoid leading questions, and how to follow up with more questions when initial information is retrieved. Furthermore, the cognitive interview technique requires good inter-personal skills, interview management skills, patience, and an aptitude to remember all rules and directives. Additionally, the cognitive interview requires the interviewer to be a good note taker so that all information is recorded correctly. Not all personnel have the opportunity or time to train for the cognitive interview technique limiting the techniques employment. Further, after extensive training in the cognitive interview technique, research has shown that success varies depending on the individual conducting the interview. Finally, the cognitive interview takes several hours and requires the full time presence of the interviewer. In law enforcement, for example, not all officers are willing to spend the time required for a good interview working with one witness.

Even more difficulties are related to the presence of the interviewer. In a law enforcement context, victims and witnesses are often unwilling to report to the police because they fear repercussions or are too ashamed to report. For example, in neighborhoods with many gangs, people do not want to be seen talking to the police. Crimes also go unreported because witnesses are too embarrassed, especially in the case of sexual offences or when the witnesses are young. Moreover, many crimes go unreported because people do not want to make the time investment since they believe it will not matter. Social and cultural norms can also have an effect. Women may not want to be in the physical proximity of the interviewer because they feel threatened or because of social and religious stipulations. In a medical context, such an intensive interview process can not be possible due to illness or because of stigma, such as, for example, when interviewing AIDS patients about their sexual habits. Shame and reluctance to interact with people, such as, for example, when interviewed about topics considered ‘private’ such as sexual interactions or drug use, can form similar obstacles to in-person interviews.

In response to problems with the time commitment of the interviewer and the need for an in-person interview, a different version of the cognitive interview, a self-administered version, has recently been developed. This approach reduces the time and effort required by police while being less embarrassing for the interviewee. Although solving one problem, it introduces others. This version lacks the interactive component of the original cognitive interview which has been shown to lead to more information when used appropriately.

Other automated interview systems, unrelated to the cognitive interview, exist. However, these use a set of predefined and pre-ordered questions. For example, in medicine, an interview is used to question patients about sexual behaviors. Other computer-based techniques that interact with people, such as online therapy do not extract as much information as possible or, to organize questions to retrieve that information. Very often, the technology only provides the medium and the interaction is conducted between two or more people. For example, in law enforcement, aside from answering the phone of a tips-line, the most common automated approach to receiving crime information is a website where witnesses can submit tips. These websites are not interactive, contain only a few closed-end questions, such as, for example, ‘where’ did the incident happen or can be combined with a simple text box for typing a statement. The original, plain and unprocessed information submitted is stored in the original format. It requires police offers or lawyers to read and interpret the submitted statements.

There is a strong need and great opportunities for a computer system and method that can interact with the interviewee, engage the interviewee in a dialog, assist the interviewee in recalling information about an event using principles of psychology, and store the information in a structured manner. Current methods to gain information from people are suboptimal or require a significant time investment and training of an interviewer.

Therefore, there is a need for a system for assisting an interviewee in remembering and recounting information about a prior event using a cognitive interview and natural language processing that overcomes the problems of the currently available interview techniques.

### SUMMARY

The present invention meets this need by providing a computer based system for assisting an individual in remembering and recounting information about a prior event using a cognitive interview and natural language processing. In one embodiment, the system comprises a computer generated interactive user interface; an interview component operably connected to the interactive user interface component comprising an interview algorithm, where the interview algorithm provides multiple instructions and questions according to the principles of a cognitive interview; a natural language processor operably connected to the interview component comprising a text processing algorithm, where the text processing algorithm interprets user input in natural language; and a storage component operably connected to the natural language processor. The interactive user interface component is configured to provide questions based on cognitive interview principles to an interviewee, an interviewer, or both the interviewee and the interviewer. The computer generated interactive user interface component further comprises a voice recognition processor for receiving input from an interviewee, providing output to the interviewee or both receiving input and providing output to an interviewee and further comprises audio-visual aids to aid the interviewee in answering the questions.

In another embodiment, the interview component is configured to influence the mood of the interviewee, pose appropriate questions to the interviewee, process answers given by the interviewee, store the answers given by the interviewee in a structured format, provide feedback to the interviewee on information previously stored in the system via the interactive user interface, to change questioning tactics using input received from the interviewee, and transmit questions to the interface component in an order determined by principles of the cognitive interview.

In one embodiment, the natural language processor comprises a tokenizer operably connected to the natural language processor for delineating tokens, words, or both tokens and words; a sentence splitter operably connected to the natural language processor for delineating individual sentences; a parts-of-speech tagger operably connected to the natural language processor for combining the tokens, words and sentences with a linguistics lexicon and a set of linguistic rules and an assigned part-of-speech to teach work; a chunker operably connected to the natural language processor for tagging verb phrases, noun phrases and other types of word chunks based on the users native language; and a disambiguator for determining the intended meaning of a word or phrase by examining the linguistic context in which the word or phrase is used.

In one embodiment the storage component further comprises a timestamp.

In another embodiment, the storage component comprises a first storage area for storing an original narrative text, a second storage area for storing information extracted from the narrative text, a third storage area for storing a listing of topics and items, a fourth storage area for storing answers obtained by the system, where the answers are stored with information about topics and items used by the system.

In one embodiment, the system further comprises a scoring component operably connected to the natural language processor and the storage component for scoring the answers given by the interviewee based on dimensions of interest provided by the interviewer. The dimensions of interest in the scoring component comprise a general order, detail level of information, difficulty of information, stress levels of the interviewee, importance of the questions asked, time taken to answer the questions asked, random, interviewee preference, interviewer preference, relevance, quality of previous information, availability of information from other sources, quality of information from other sources, time, sensitivity of information, reference point, and previously provided information.

In another embodiment there is provided a method of assisting an individual in remembering and recounting information about a prior event using a cognitive interview and natural language processing, the method comprising the steps of: a) providing the system of assisting an individual in remembering and recounting information about a prior event using a cognitive interview and natural language processing; b) performing a first narrative interview according to the principles of the cognitive interview to provide information regarding an event; c) recording the information using natural language; d) conducting an interactive process of follow-up questions and answers after the first narrative has been received; e) processing one or more narratives using natural language processing techniques; f) performing entity extraction from the one or more narratives to identify information entities of interest; g) storing the extracted information and the one or more narratives in a structured format; and h) time stamping the stored information.

In one embodiment the method further comprises the steps of: a) prior to the first narrative, informing an interviewee using an interface component of the system's purpose and the procedure that is followed; b) reassuring the interviewee about the importance of the task, usefulness of the information, and importance of including all details; c) explaining the interface component and special functions; and d) including initial questions, not specified as part of the cognitive interview, for adjusting the interviewee's stress levels during the interview. The questions asked and answered in the one or more narratives are tracked and stored. The amount and quality of information in the one or more narratives is tracked and stored. The order of topics and the questions asked are adjusted depending on the ongoing interaction and are adjusted depending on a difference in answers to similar questions that are tracked during the interview and cognitive interview principles.

In one embodiment, the questions asked are adjusted based on how much stress a previous question caused, how information was remembered about the event by the user, the importance placed on the previous question by the user, and how far in the past that the event occurred. Additionally, the questions asked can be repeated and a set number of attempts to get information from the interviewee on a specific detail are pre-set. Also, the questions asked to the interviewee are scored on dimensions of interest, where the dimensions of interest are selected from the group consisting of a general order, detail level of information, difficulty of information, stress levels of the interviewee, importance of the questions asked, time taken to answer the questions asked, random, interviewee preference, interviewer preference, relevance, quality of previous information, availability of information from other sources, quality of information from other sources, time, sensitivity of information, reference point, and previously provided information. The dimensions of interest score alters the ordering of questions and topics during the interview.

In another embodiment, the questions asked are adjusted by one or more dimensions and are grouped into one or more topics and all questions in a topic are asked and answered before beginning a new topic to minimize the number of switches between topics. The questions are generated for all topics that require information. The topic order is adjusted using a detail-level, a difficulty-level, an importance level, and a dimension.

### BRIEF DESCRIPTION OF THE DRAWINGS

These and other features, aspects and advantages of the present invention will become better understood with regard to the following description, appended claims, and accompanying figure where:

FIG. 1 is a diagram of a system for assisting an interviewee in remembering and recounting information about a prior event using a cognitive interview and natural language processing;

FIG. 2 is a flowchart of a method operation of the system of FIG. 1 according to one embodiment;

FIG. 3 is a block diagram of the natural language component of the system of FIG. 1 according to one embodiment;

FIG. 4 is a flowchart of a method for generating questions for a cognitive interview according to one embodiment;

FIG. 5 is a flowchart of a method for ordering and adjusting topics for the cognitive interview using different dimensions according to one embodiment; and

FIG. 6 is a table of topics and items, a general order of the topics and items and a level of detail and stress associated with each item according to one embodiment.

### DETAILED DESCRIPTION

The present invention is substantially different from the interview methods described above. It addresses the shortcomings described above and adds additional, new advantages. The combinations of interface design, natural language processing, and database storage to enable a cognitive interview-style interaction make this invention unique. It solves the problems of existing interview techniques and brings additional advantages discussed below.

This invention uses an interview technique based on the cognitive interview, a set of principles based on psychological research that help and encourage people to remember more information about an event they witnessed. The invention is controlled by a computer program, which can interact autonomously with a person, influence the mood of the person, and pose appropriate questions while processing and storing the answers in a structured format and giving the interviewee feedback on information already stored. The invention can be used as a standalone program that interacts with the interviewer. However, an interviewer can also act as an intermediary between computer and interviewee. The invention can use alternative input and output devices, such as mobile devices and voice recognition, to augment the interaction. The input and output methods can include spelling checkers and multi-media.

The following description details the principles and components that constitute this invention. To facilitate the explanation, one example is used to demonstrate the principles: reporting of information of a crime by a female witness. However, the system is not limited to law enforcement applications and other topics can be covered. The system is also not limited to the English language, since the principles are applicable to all humans, not only those speaking English, and the necessary language processing components can be developed and combined for any language.

Methods, systems and devices that implement the embodiments of various features of the system will now be described with reference to the drawings. The drawings and the associated descriptions are provided to illustrate embodiments of the system and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Throughout the drawings, reference numbers are re-used to indicate correspondence between referenced elements. In addition, the first digit of each reference number indicates the figure where the element first appears.

As used in this disclosure, except where the context requires otherwise, the term “comprise” and variations of the term, such as “comprising”, “comprises” and “comprised” are not intended to exclude other additives, components, integers or steps.

In the following description, specific details are given to provide a thorough understanding of the embodiments. However, it will be understood by one of ordinary skill in the art that the embodiments may be practiced without these specific detail. Well-known circuits, structures and techniques may not be shown in detail in order not to obscure the embodiments. For example, circuits may be shown in block diagrams in order not to obscure the embodiments in unnecessary detail.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be rearranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, a storage may represent one or more devices for storing data, including read-only memory (ROM), random access memory (RAM), magnetic disk storage mediums, optical storage mediums, flash memory devices and/or other machine readable mediums for storing information.

Furthermore, embodiments may be implemented by hardware, software, firmware, middleware, microcode, or a combination thereof. When implemented in software, firmware, middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or a combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted through a suitable means including memory sharing, message passing, token passing, network transmission, etc.

In the following description, certain terminology is used to describe certain features of one or more embodiments of the invention.

The term “machine readable medium” includes, but is not limited to portable or fixed storage devices, optical storage devices, wireless channels and various other mediums capable of storing, containing or carrying instruction(s) and/or data.

The term “computing device” includes, but is not limited to computers, cellular telephones, hand held computers and other devices that are capable of executing programmed instructions that are contained in a storage including machine readable medium.

The term “interviewee” refers to a person, or user of the system who is to be interviewed by the system.

The term “interviewer” refers to a person that can assist in asking questions provided by the system.

The term “audio-visual aids” refers to pictures, diagrams, charts, etc. that can be used to affect the recall of information.

The term “dimension” refers to a level to indicate the importance of information and ensures that the most important questions are asked first.

The term “difficulty,” as applied to the cognitive interview, refers to personal angst and other personal and social norms that restrict the interviewee 102-104 from freely discussing information.

The term “entity” refers to parts of natural language, such as, for example, nouns, verbs and adjectives or entire phrases depending upon the field of the interview.

The term “lexicon” refers to a list of words with their possible labels.

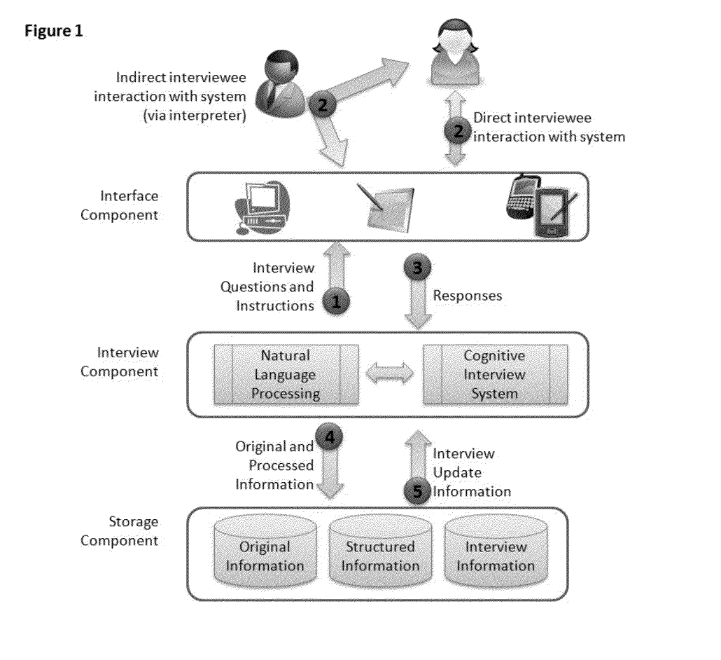

Referring now to FIG. 1, there is shown a diagram of a system 100 for assisting a interviewee 102-104 in remembering and recounting information about a prior event using a cognitive interview and natural language processing. The system 100 can be used indirectly by an interviewee 102-104 through an interpreter or at a remote location, or directly by an interviewer located proximate to the system 100. The system 100 comprises three main components: the interface component 106, the interview component 108, where the interview component 108 comprises a natural language processing component 112 and a cognitive interview system 114, and a storage component 110, where the storage component 110 comprises original information storage 116, structured information storage 118 and interview information storage 120. The interface component 106 of the system 100 displays instructions, questions, and feedback to the interviewee 102-104 either directly 104 or indirectly 102. The instructions, questions, and feedback can be provided by the interview component 108. The information from the interviewee 102-104 is input into the system 100 using natural language processing 112. The cognitive interview system 114 manages how the interview is conducted using cognitive interview principles. Once the information has been processed the processed information is stored in the storage component 110 in storage location 116, 118 and 120.

The interface component 106 component can be a computer screen where questions and instructions are shown as text. However, the same instructions and questions can also be presented by audio or by a human intermediary. The interviewee 102-104 use the interface component 106 to dictate or type their responses. In addition, the interface component 106 can also present images, such as, for example, colors or guns, for the interviewee 102-104 to choose in response to questions.

The interview is based on the principles of the cognitive interview. The interview starts by informing an interviewee 102-104 via the interface component 106 of the system's 100 purpose and the procedure that is to be followed for the interview. The interface component 106 also reassures the interviewee 102-104 about the importance of the task, usefulness of the information, and the importance of including all details. The interface component 106 and any special functions it can have, such as, for example, a “pause function” or “logoff function”, will be explained. Initial questions, not specified as part of the cognitive interview, can also be included. For example, interview questions about an incident's location, such as, for example, the time and place; or about the interviewee 102-104, such as, for example, name, gender, status, witness, victim; or about the crime, such as, for example, type of crime or severity of the crime, can be included. This information can be taken into account during the interview when stress level adjustments are made. Following this preamble, the interview proceeds according to the principles of the cognitive interview. The interviewee 102-104 receives instructions on how to prepare for the interview and is invited to report information. The interviewee 102-104 is invited to relax, close their eyes and take time to visualize the event. Once the interviewee 102-104 is ready, they are invited to report as much information as possible on the event. The information is reported using both natural language and a narrative. The interviewee 102-104 is encouraged to include as much information as possible. The information can be entered into the system 100 by the interviewee 102-104 by typing or speaking. Once this first narrative has been received, the interview continues with an interactive process of follow-up questions and answers.

The narratives are processed using natural language processing 112 techniques. Common natural language processing 112 processes are executed, such as, for example, to recognize verbs and nouns, and entity extraction is used to identify information entities of interest, such as, for example, recognizing weapons, clothing, or events. The natural language processing 112 module also takes care of recognizing slang, such as, for example, common abbreviations such as b/f for boyfriend, but also slang for sexual acts or drugs, synonyms, abbreviations and other special names, such as, for example, gang names, that need to be recognized. Entities of interest depend on the application domain: they can be general or can be tuned to a specific field such as law enforcement or medicine. The extracted information is stored in a storage component 110 in a structured format. The extracted entities are stored in a structured information storage 118. For example, entity labels can be general and high level, such as ‘person’, ‘car’ or ‘time’, but can also be part of a structured set of items such as from a police report, such as, for example, ‘escape vehicle’, ‘stolen property’, or from relevant medical report, such as, for example, ‘life event’, ‘sexual activity’.

The original narratives and the extracted information are both stored together with a timestamp in an original information storage 116. Throughout the process, the system tracks the questions asked and answered, and the amount and quality of the received information and stores these items in an interview information storage 120 for processing by the system 100. Follow up instructions and questions about additional specific topics and items are presented based on the information received and processed by the system 100. The order of topics and questions can be adjusted depending on the ongoing interaction and cognitive interview principles. For example, the stress level (stress dimension), how detailed an item is (detail dimension), or how important a topic is (importance dimension) are used to order and reorder questions and topics. The topic is changed when necessary, previous topics are revisited when necessary, and instructions are added when necessary.

An example of how the system 100 can be used, according to one embodiment, is for interviewing a victim or witness of a crime. The interviewee 102-104 testifies as to what they saw when the crime was committed. However, the interviewee 102-104 can be embarrassed, scared, or disoriented and the interviewer, such as, for example, a police officer, may not be trained in optimal interview principles or may not have the required time to conduct a thorough interview. The present invention can insure that all the information required is obtained. Other examples of interviews that can be conducted with the system 100 involves an interviewee 102-104 that is geographically disparate location from the interviewer, the interviewee 102-104 cannot be interviewed because of social restrictions, or the interviewee 102-104 is too embarrassed to be interviewed in person.

The system 100 provides advantages and solutions that the individual components cannot provide. The system 100 is unique because of how the components are combined and integrated. One advantage is that the system 100 leverages principles from the cognitive interview to help recount and report more information, leading to more information retrieved than can be achieved with existing approaches. The system 100 also provides a solution to many interviewer limitations, such as the need to manage the interview and know which questions to ask when, to take good notes, while maintaining optimal language and social skills use. The system manages the interaction between interviewee 102-104 and computer, no interview training of personnel is required. Personnel need not be present for the duration of the interaction. However, in the case where it is advantageous or necessary to have a human in the loop, the system can serve as the guide for an intermediary. In this case, two people will interact, but the interview will follow the prompts and instructions from the system. The answer can be submitted by this intermediary or directly by the interviewee 102-104.

Using the system 100, interviews can be conducted anonymously or with an identified person. In one embodiment, the system 100 can be used as a standalone component in an office. In this case, the identity of the interviewee 102-104 is known and can be recorded. In another embodiment, the system 100 can be used via the Internet where the system resides centrally but the interviewee 102-104 submitting the information uses a computer or other devices in a different location so that the interviewee 102-104 can remain anonymous. Because there is no need for human contact, the interviewee 102-104's embarrassment and fear will be reduced. Also, any social or religious obstacles to sharing information by the interviewee 102-104 can be avoided.

The system 100 also addresses practical limitations of current systems, such as the need for geographical proximity, having to allocate large blocks of time to conduct interviews, and the necessity for carrying around visual aids to assist in the interview. The interview can be paused and resumed later at the convenience of the interviewee 102-104 without the need to reschedule with an interviewer and organize an interview space.

Finally, the system 100 makes use of technology to surpass existing approaches by providing interaction, the use of visual aids, and advanced methods to store information. Many memory aids can be used. For example, when describing colors, it is difficult to describe an exact color, but it is easy to select a color from a set of colors. It is difficult to identify a gun or car, but it's much easier to choose from available example images. Carrying around all necessary and useful images is not practical, but the system 100 can easily accommodate this need.

Interview Process

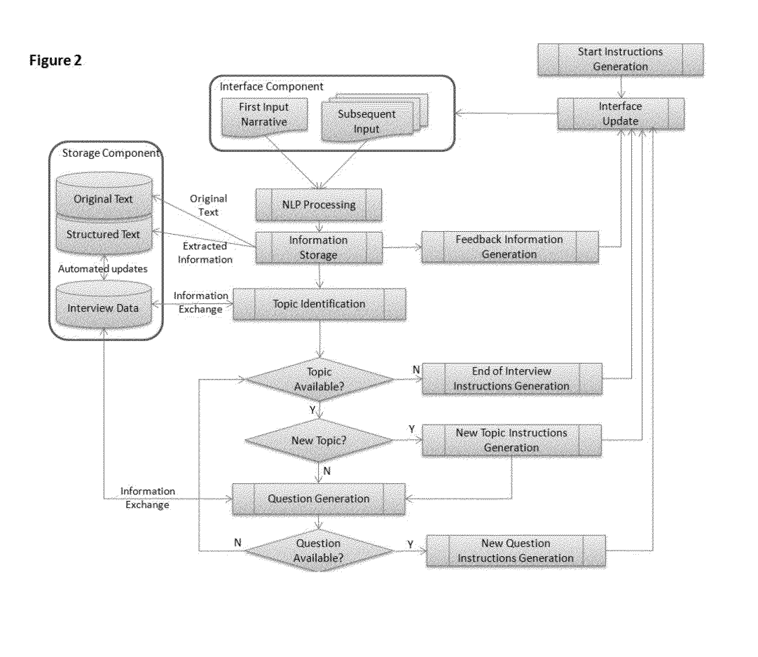

Referring now to FIG. 2, there is shown a flowchart of a method operation of the system of FIG. 1 according to one embodiment. As can be seen, first, the interview starts by providing instructions to the interviewee 102-104 to reconstruct a mental image of an event. Next, any special instructions to the interviewee 102-104 on providing information, how to use the interface component 106 to pause, stop, or continue an interview can be included.

Then, the interview will begin with the first input narrative 208 and questions with instructions are displayed on the interface component 106. Next, the interviewee 102-104 is instructed to mentally reconstruct an event, this requires a period of time before the interview can be started. Optionally, the time delay can be preset, for example, 15 seconds can be set as the delay prior to beginning the interview. Then, the interviewee 102-104 receives the first general question, and the interviewee 102-104 starts reporting as much information as possible regarding the question asked. Answers to the questions are provided by the interviewee 102-104 as natural language text either verbally or textually. Next, the natural language text is processed using natural language processing 210 and entities are extracted from the natural language text and are stored 212 in the storage component 110. A pause detector 215 is provided to adjust the interview process during prolonged periods between answers so that the questions asked can be adjusted based on a variety of factors, such as, for example, a thoughtful pause, a nervous pause, etc. The interface component 106 is also updated 204 to provide the interviewee 102-104 feedback 214 on the information already received. Then, topics are identified 216 from the storage component 110. Next, a determination is made as to the availability of a topic 218 based on the amount of information provided and the order of questions to be asked. If the topic is not available, end of interview instructions generator 226 updates 204 the interface and the interview ends. If the topic is available 218, then a determination is made 224 whether the topic is a new topic or a previously presented topic. If the topic is new, then new topic instructions are generated 226, a new question is generated 228 on the new topic and the interface is updated 204. If the topic is not new, a new question regarding the topic is generated 228 based on the information in the storage component 114 and cognitive interview principles. The question generated 228 is also stored in the storage. A determination if the question generated 228 is available 230. If the question is available, then new question instructions are generated 232 and the interface is updated 204. If the question is not available, another topic is selected 218 and the process repeats until all available topics and questions have been answered by the interviewee 102-104. Each answer provided by the interviewee is processed, stored, and feedback on the amount and quality of the information received is shown to the interviewee 102-104 using interface updates 204.

As can be appreciated, a topic is a broad category of information of interest. An item represents a detail and belongs to a topic. The interview continues until the list of topics and items is exhausted, when no information is provided after a predefined number of attempts, such as, for example, two attempts, or when the interviewee 102-104 decides to end the interview. At the end, the interviewee 102-104 sees the reported information and can revise the information or add details. The system keeps track of all changes made. The interviewee 102-104 can stop the interview and start the interview again at a later time. The system 100 will resume the interview at the point in the interview where the interview was stopped.

The user interface component 106 provides the interviewee 102-104 with tools to login in to the system for the first time, or for a repeated number of times, to submit information, skip questions, listen to instructions in alternative ways (voice, text), and see feedback on information received and still needed.

The interviewee 102-104 has the option to skip a question. When questions are not answered, this is stored and taken into account when ordering follow-up questions. The number of attempts to get information on a specific detail is pre-set. For example, when the number of attempts is 1, then a question not answered will not be repeated.

The interface component 106 provides feedback on how much information has already been provided during the interview. This is updated after each answer submitted by the interviewee 102-104. Examples of how feedback can be displayed are progress bars for different topics, such as, for example, suspect, events, etc., or more detailed visualizations or listings.

An interviewee 102-104 has the option to review information already provided. When the interviewee 102-104 makes changes, these changes are stored and information is also stored about the nature of the change, such as, for example, timestamp, type of information change, original information.

Natural Language Processing and Information Extraction

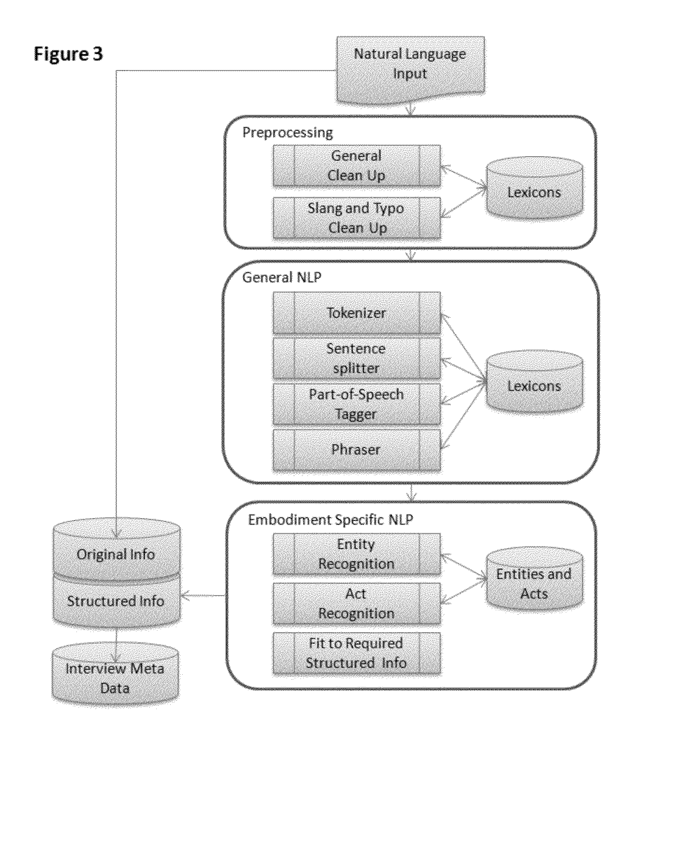

Referring now to FIG. 3, there is shown a block diagram of the natural language component of the system of FIG. 1, according to one embodiment. After a natural language input 302 is received by the system 100, the natural language processing component 112 preprocesses the text 304, extracts the general natural language processing component 306, identifies specific and transmits the information to the correct storage component 334, 336 and 338. Preprocessing 304 the natural language input 302 received can occur either before or during tagging. During preprocessing 304, the natural language input 302 is generally cleaned up 310 using lexicons. Slang input and typos can be corrected 310 as needed. The components provide the basic lexical and grammatical information that will be used by the next set of components.

The general natural language processing component 306 comprises a disambiguator 317, a tokenizer 318, a sentence splitter 320, a parts-of-speech tagger 322, and a phraser 324 for identifying chunks of verb and noun phrases. The tokenizer 318 delineates tokens (or words) in texts and the sentence splitter 320 delineates individual sentences. The part-of-speech tagger 322 combines this information with linguistics lexicons 316 and uses a rule-based or statistical approach to add parts-of-speech. The part-of-speech tagger 322 indicates whether a word is noun, verb, determiner, etc. Once the part-of-speech tagger 322 has labeled the words, noun phrases, verb phrases, prepositional phrases and other types of word chunks, are tagged by the phraser 324.

Once words and phrases are identified, they can be labeled. A Lexicon 314-316 is used to map words to labels. The lexicon 314-316 is a list of words with their possible labels, such as, for example, Colt 45 is listed as ‘revolver’, ‘man’ can have multiple labels, such as ‘male’, ‘suspect’, ‘person’, ‘witness’. A disambiguation module 313, 317 and 327 selects the best match in the given context. The disambiguation is based on the surrounding context and can be rule-based or can use machine learning. Commonly used disambiguators are naive Bayes algorithms trained on a gold standard of correctly tagged texts. The leading question in this interaction is helpful in disambiguating the words.

An embodiment specific natural language processing component 308 can be used to enhance the capabilities of the system 100, such as, for example, a specific language to use (i.e. English, Spanish, Italian, etc.), and the topic, such as, for example, law enforcement. For example, the word ‘test’ can receive a different label in the specific natural language processing 308 depending on the application domain, such as, for example, ‘diagnostic test’ in a clinical context but ‘exam’ in an educational context. In one embodiment, the specific natural language processing component 308 comprises an entities and acts lexicon 326, an entity recognition component 328, an act recognition component 330 and a fit to required structure information component 332.

All words and phrases that can be matched and labeled are extracted and stored. This process happens regardless of the leading question. For example, if the witness is describing the runaway vehicle and suddenly remembers and describes the shape of the tattoo on the suspect's arm, this information will not be disregarded because it is not a direct answer to the question. It will be stored in its appropriate place and labeled as a tattoo. As such, no information is lost and the amount of information, used to guide selection of new topics, is always up to date.

Information Storage

The date and time of the interview are recorded with the information. If information is submitted later, such as, for example, a second interaction with the system several days later, all information is tagged with this time stamp. If the embodiment requires repeat questions, such as, for example, questions to be asked multiple times for verification, all information is tagged with a number indicating when it was stored. In addition to the original narrative text, the information that is extracted from the narrative is stored separately as an entity.

Questions are generated for all topics and for all individual items for each topic. The listing of topics and items, such as, for example, car, person, hand, face, weapon, is essential in generating questions but does not limit where answers are stored. The answers with information about topics and items are stored in the appropriate place. For example, when asking about the “hand”, a suspect can note that they felt “rough” and had “calluses”. However, when providing information on a different topic or item, this information is also stored in the appropriate place. For example, an interviewee 102-104 could describe the different rings when asked about hands.

There are multiple levels in the hierarchy. The examples used here only use two levels in the hierarchy. For example, ‘face’ is a topic and ‘face shape, eyebrows, eyes, eye color, nose, lips are items in the ‘face’ topic. Topics and items of interest depend on the context of the application. For example, a law enforcement agency can be interested in getting answers that fit their standard reports and include topics such as “overall appearance, clothing, . . . ”. More detailed sets of topics and items can be deduced from thesauri or ontologies, or can be created ad hoc for a specific embodiment. For example, “I saw a white Toyota”, could be stored as the phrase “white Toyota”/[car] or could be stored in more detail as “white”/[car color] and “Toyota”/[car brand].

Question Order

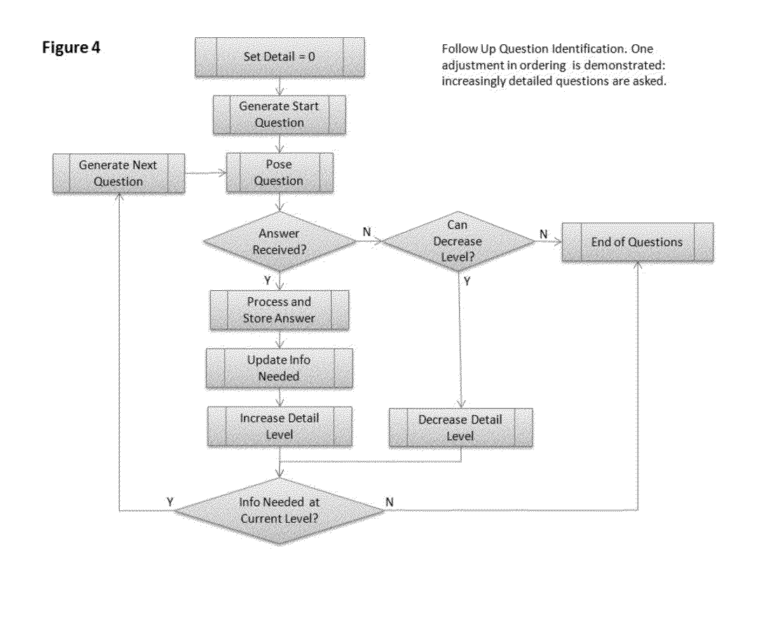

Referring now to FIG. 4 there is shown a flowchart 400 of a method for generating questions for a cognitive interview according to one embodiment of the present invention. In one embodiment, the general ordering of questions posed 406 to the interviewee 102-104 is adjusted using one dimension, the level of detail. First, a detail level is set to zero 402. Then, a start question is generated 404. Next, the start question is posed 406 to the interviewee 102-104. Then, a determination is made if an answer is received 408. If the answer is not received, then a determination is made whether the detail level can be decreased 422. If the detail level cannot be decreased the questions end 424, else the detail level is decreased 420. If the answer is received 408, then the received answer 408 is processed and stored 410. Optionally, if the answer received 408 is not directly relevant to the question asked, the information is still stored in an appropriate storage location 116-120. Next, an update of the information needed is processed 412. Then, the detail level is increased 414. Next, a determination is made whether all information needed at the current detail level has been discovered 416. If there is more information needed at the current level then a next question is generated 418 at either an increased detail level or a decreased detail level. This questioning generating strategy exhausts a current topic with more and more detailed questions before moving to the next question.

It is essential that a set of topics with items that are of interest is prepared prior to the interview. Each topic and item is numbered indicating the order that the topics should be discussed in the interview. The general order is prescribed by principles of the cognitive interview, such as, for example, from the top of the head (hair) to the bottom (chin). Questions are asked in the given order. However, each item is also scored on other dimensions of interest, such as for example how detailed the item is, how much stress it will cause the interviewee 102-104 to talk about the item, how important is the item, how difficult it is for the interviewee 102-104 to recall the information, and whether the interviewee 102-104 has already provided information for the item, interviewee 102-104 preferences, interviewer preference, relevance of the information to the case, investigation, or study depending on the embodiment, quality of previous information given by interviewee 102-104, availability of information from other interviews or other sources, quality of information from other sources, time, sensitivity of information, and reference point for the question. The scores on these dimensions can influence the ordering of questions and topics during the interview. The first ordering, which is set before the interview, is dynamically adjusted during the interview process 400 in response to answers of the interviewee 102-104. Multiple dimensions are used to adjust the order of the questions. More dimensions are added as necessary, such as, for example, a level to indicate the importance of information ensures that the most important questions are asked first, random, interviewee preference, interviewer preference, relevance, quality of previous info, availability of information from other sources, quality of information from other sources, time, sensitivity of information, reference point. Each such adjustment helps steer the questioning. The dimensions themselves have weights to avoid gridlock and to allow importance of dimension to change in different instances, e.g., in some applications importance and relevance are more important to order questions than stress.

Whether questions are generated for a topic depends on the amount of information already received. In one embodiment, also used in the examples, questions are limited to asking about missing information and questions are not repeated. As a result, if information has been provided for an item, no question is generated for that item. If information has been provided for all items of a topic, no question is generated for the topic. For example, if the initial narrative provides information on the nose shape of a person, no further question is generated about the person's nose. However, in a second embodiment, questions can be repeated for later comparison of information. Questions are then repeated for a predefined number of times or while contradictory information is received.

Topic Order

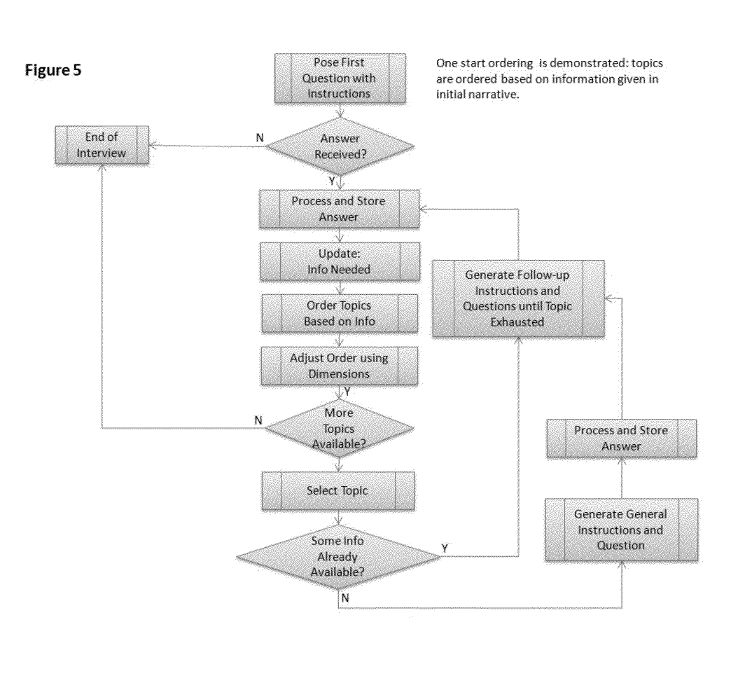

Referring now to FIG. 5, there is shown a flowchart 500 of a method for ordering and adjusting topics for the cognitive interview using different dimensions according to one embodiment. The principle behind ordering the different topics of the interview follows the same principles as the question ordering: a general ordering is established at the beginning of the interview and is adjusted as the interview goes along.

To start, a first question and instructions are posed 502 to the interviewee 102-104. Then, a determination is made as to whether and answer is received 504. Next, if no answer is to be received, then the interview ends 526, else, the answer is processed and stored 506. Then, the information needed is updated 508. Next, the order of topics is made 510 based on the updated information. Then, the order of topics is adjusted 512 using dimensions. Next, a determination is made whether there are more topics available 514. If there are no more topics available the interview ends 526. If there are more topics available, then a new topic is selected 516. Next, a determination is made if some information for the selected topic is already available 518. If no information is available, the general instructions and questions are generated 522. Then, answers to the questions are processed and stored 524. Next, follow-up instructions and questions are generated 520 until the topic is exhausted. If there is some information already available for the current topic 518, then follow-up instructions and questions are generated 520 until the topic is exhausted.

The first topic is chosen after the first narrative has been submitted and processed. After the narrative is processed, a calculation is performed to determine which of the topics received the most information. This is calculated by combining the general and detail items that were matched and stored. A first ordering of topics is based on the amount of information received. More information received makes that topic appear earlier in the ordering. If, during questioning, information is received and stored on another topic, the amount of information is adjusted during the interview. This will be taken into account when a new topic needs to be chosen.

When questions are asked about one topic, the topic is not changed when information is submitted about another topic. The goal is to finish all questions per topic before moving on to the next topic. Switching between topics requires the interviewee 102-104 to build a new mental image, which is tiring. The goal is to minimize switching between topics to minimize the number of mental images that need to be formed.

The same dimensions used to adjust the question ordering are used to adjust the topic ordering. Additional dimensions can be applied and the ordering can be based on one or a combination of multiple dimensions. For example, a topic can be very important but also very stressful. When importance is weighed more heavily than stress, the important topics will be chosen first.

When no information is received for a specific topic, this topic is treated last. One general question is asked about the topic to probe if any information is available. If the interviewee 102-104 submits information, the general principles apply. If no information is supplied, the entire topic with its details is considered ‘done’.

Importance of Each Dimension

The level of a specific dimension, such as, for example, stress level, or the weight associated with each dimensions, can be preset for different individuals. For example, importance can be weighed more heavily than stress when interviewing adults. This ensures that the important questions and topics can be covered first. When working with children, for example, the stress dimension can be considered more important in order to ensure that less stressful questions are asked first, putting the child at ease, even if this means that the more important questions are asked later.

Instruction and Question Generation

The instructions are part of the cognitive interview process and generated by the system. Although in the non-computer cognitive interview, instructions can only be presented verbally by the interviewer, with this invention, they are presented using text, audio, or via an interpreter. The goal of the start instructions is to put the interviewee 102-104 at ease and explain the importance of reporting as much information as possible. This includes clarifying that all information is important, that providing more details is better. The instructions also explain that it is unnecessary to report information in a specific order and that the interviewee 102-104 can add information other than what the question is asking for, such as, for example, when a specific detail is suddenly remembered. Instructions also reassure the person, depending on the event being reported, that fear is a natural reaction and the remembering will not be as difficult and stressful as the event itself. Example events that were very frightening are the serious crimes, such as, for example, rape, homicides, assault, and crimes with a close encounter between victim and suspect, such as, for example, a robbery, or a fight.

The instructions are supplemented by audio-visual aids, such as a screen image, background music or other recorded sounds. Visual and audio aids are used to mimic the principles of synchrony. According to this principle of synchrony, people's behaviors will resemble each other in a two interviewee 102-104 interaction after some time has passed. If one party is relaxed, the other will tend to relax too. When applied to the interview, it will be helpful to listen to the audio instructions which are presented in a relaxed manner, using calm, slow speech and a soothing voice to help the interviewee 102-104 relax.

The interviewee 102-104 is asked to imagine the event or scene mentally at the start of the interview. When an interview is taken up later, the starting instructions have adjusted instructions to include references to the previous interaction. In addition, these instructions are presented such that they put the interviewee 102-104 in a willing mood and in the best possible mind frame to recall as much information as possible. The interviewee 102-104 is explained how to concentrate and establish a mental image of the event on which she will report, such as, for example, the interviewee 102-104 could be asked to close her eyes and bring the event to mind. The system allows the interviewee 102-104 as much time as needed before starting the interview. If the interviewee 102-104 starts the interaction immediately or within a very short time span, as measured from the start of the program, the system will remind the interviewee 102-104 that it is important to concentrate and take the time necessary to establish a detailed mental image. The interviewee 102-104 will again be given the opportunity to take time before starting the interview. Taking time to mentally reconstruct the events and images will also be important whenever the topic is switched and also when interviewee seems unable to answer many questions (second attempts at answering).

After the initial instructions, a general question follows requesting the interviewee 102-104 to recall as much information as possible. As the interview proceeds, different types of instructions and questions are generated depending on the topic, item, and ongoing interaction.

Instructions are shown with a question.

When a new topic is started, the interviewee 102-104 is asked to construct a mental image and focus on the given topic. Then, a general question is generated, which does not refer to information already reported but clarifies the new topic is a new aspect. For example, a general question is used when switching from questions about the clothing of a suspect to questions about the face of a suspect. These instructions are similar to the start instructions, but adjusted for the topic to come, such as, for example, the positions of the people in the scene.

For each topic, questions are generated for all items that require information. The accompanying instructions refer to previous information when the item is more detailed than the previous. Additional short instructions are added to the question and the previous answer is mentioned in the questions. For example, if the interviewee 102-104 has reported on seeing a gun, a question about the shape of the barrel of the gun (more detailed item) will refer back to the interviewee's 102-104 mentioning of a gun. The instructions will ask her to concentrate on that aspect. In this manner, the instructions help keep the interviewee 102-104 focused. For example, when a car has been described in general and a question follows about the color of the car, the instructions will include a reference to the current topic, such as, for example, “Please try to image the car again. Can you remember the color of the car?”

Questions are as open-ended as possible. For example, a question about the shape of a face would be “Please describe the shape of the face” but not “Did the suspect have a round face?” (this second one is a close-ended, leading question). An advantage of this invention is that questions can be guaranteed to be neutral. It is very difficult to ask such neutral, non- leading questions when doing an in-person interview, especially when multiple witnesses are interviewed.

Questions can be stand-alone or relative, i.e., refer to another known fact for comparison. When personal information about the interviewee 102-104 is available, relative questions are preferred. When no personal information is available, no relative questions are used. For example, when asking about the height of a suspect, the question is given as “Can you tell how much taller or shorter the interviewee 102-104 was compared to you?” Details such as build, height, weight, age are suitable for these type of questions. It should be noted that these personal questions are different from identifying questions. Knowing how tall someone is, is different from knowing her name.

Some answers to questions can be best presented as choice boards. This is for items where the details are especially hard to verbally describe or for which people have different standards. For example, colors can be chosen from a color chart. Gun types or gun barrel types can also be chosen from a set of images. Especially with more specialized topics, such as car types or guns, this avoids incorrect answers. For example, many people do not know the difference between an automatic and semi-automatic gun when they see it, but often can point out the shape of the barrel or handle (which helps identify the gun).

The instructions are further fine-tuned based on the dimensions and the information already provided. When a question remains unanswered, the instructions will include a note that the interviewee 102-104 can include the information at a later time, or that the system will come back to a question later. When the stress level is high, instructions remind the interviewee 102-104 about the importance of the information provided in solving the crime and reassure the interviewee 102-104 that trying to remember the information will be less stressful than the actual event. This helps put the interviewee 102-104 more at ease. When the interaction indicates the interviewee 102-104 is not concentrating anymore, such as, for example, when multiple questions are ignored in rapid succession, the instructions can recommend a short break, remind the interviewee 102-104 about the importance of the information, or recommend that the interview is taken up later. The suggested actions will depend on the interview progress, such as, for example, suggest a break if the interview has taken more than an hour.

At the end of the interview, final instructions and recommendations are presented. This includes information on where additional information can be reported, how to access the system or contact people. If anonymity is important, a random user name and password can be generated for future use.

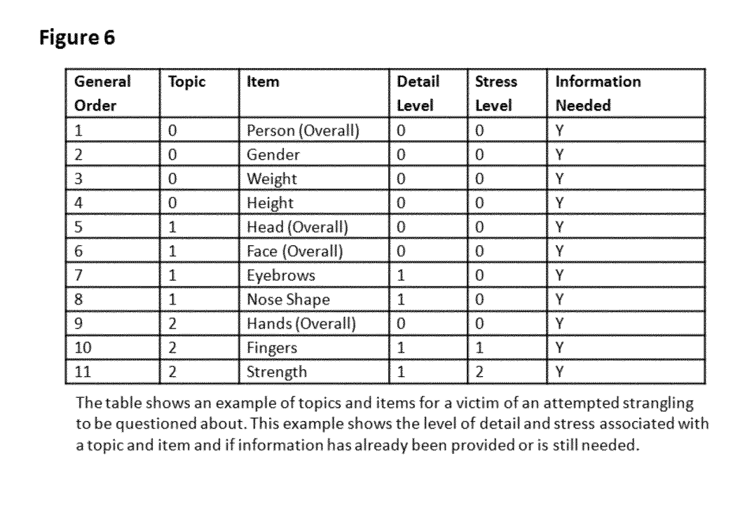

Referring now to FIG. 6 there is shown a table 600 of topics and items, a general order of the topics and items and a level of detail and stress associated with each item according to one embodiment. The table 600 shows an applied example of question ordering with two dimensions, detail and stress, for a victim of an attempted strangling. As can be seen, there is a beginning general order 602 to the questions to be asked. There are three topics 604 to be reported (see topic column): the person's overall appearance (topic 0), head (topic 1), and hands (topic 2). Within each topic 604, there are different items 606 that comprise more detail, such as, for example, ‘eyebrows’ represents a more detailed item than ‘face.’ The detail level 608 refers to the amount of information needed 612 to be gathered in the interview. The stress level 610 refers to how stressful questions regarding the items 606 are expected to be to the interviewee 102-104. For example, when reporting on an attempted strangling, questions about the hands of the assailant will be more stressful to the interviewee 102-104 than other questions. When a question about the overall shape of a suspect's face (detail level 0) receives an answer, the level of detail would be increased to 1 and the next question at this level would be asked, such as, for example, eyebrows (level 1) if no information has been received regarding eyebrows. This cycle continues so that the questions delve into details. If no more detail level 608 exists, the detail level 608 is decreased and a question is generated for the next item 606 that does not yet have information, such as, for example, eyes (level 0), followed again by more detailed questions, such as, for example, eye color (level 1). When no answer is received for an item 606, the level of detail 608 is not increased. When no more items 606 are available, the questions end for the given topic 604 and question for the next topic 604 are asked.

The stress, details, and difficulty dimensions are adjustments required by the principles of the cognitive interview. Additional levels are added depending on the specific embodiment and in which context it is used. The level of importance and the information already received are additional dimensions to steer the interview questions. The levels are set before the interview starts but can be the same for all interviews or adjusted per type of interview. For example, with crime reporting, stress levels would look different in a homicide-witness interview than a burglary-witness interview. Similarly, with homicides, the description of people can be more important than with a burglary.

Stress-level: Each item and topic has a stress level indicator. The most stressful questions are not asked at the start of the interview.

Detail-level: Each item and topic is associated with a detail score. A topic question is asked first when introducing a new topic. The item questions follow. Very specific items ask for technical information. These items are important and need to be asked explicitly because non-experts usually do not consider this to be important information and do not report it. For example, how the handle or the barrel of a gun looks helps identify the type of gun it was.

Difficulty-level: Each question has an associated difficulty level. The definition of difficulty depends on the embodiment of the systems, such as, for example, interviewing crime witnesses or AIDS patients about their sexual behavior is considered asking for difficult information. Easier questions are used to start the interview.

Importance level: Some questions are more important than others. Since doing a cognitive interview is fatiguing, important questions should be asked at the beginning. Their order information will ensure they are asked early on.

Previously-asked: When questions have been asked already but the interviewee 102-104 could not provide an answer, the order of the question is changed when asked a second time. The order can be reversed or a different starting point can be chosen.

Several interface component 106 enhancements are available and adding additional ones does not change the scope of this invention. The enhancements improve the input and output options. For example, before starting the interview, the interface component 106 can visualize the time delay or disable a ‘start’ button until a minimum amount of time has passed, or show a clock. The system 100 can receive input by using voice recognition so that the interviewee 102-104 does not have to type. The interview could also be done over the phone instead of using a computer and keyboard. The system can use voice to provide the instructions and questions. Drawings can be accepted during the interview, such as, for example, to show positions, as well as sound recordings, such as, for example, mimicking the sound the gun made.

The system 100 described here can be used on a website connected to a server or as a standalone computer. It does not require human invention. One component of this invention has been tested and shown to be successful. For this first test, one paragraph of instructions was provided, the information processing dealt with the interviewee 102-104 descriptions, and the question sequence was only adjusted when information was already available on an item and no further questions were necessary. The component did not adjust the questions used based on the principles of the cognitive interview and did not incorporate the stress, details, or any of the other dimensions, including the important principles of the interview. Further, the component did not come back to previously unanswered questions, did not incorporate special cognitive interview instructions during the interview, lacked audio and visual medic components, and did not allow people to pause or interrupt the interview. Even so, a user study showed this component to be superior to the commonly used tips-websites and almost as efficient as an in-person interview for the items incorporated in the component, i.e., questions about a suspect's appearance.

FIG. 6 shows a table to demonstrate the dimensions; however, this system 100 is not limited to storage of information using tables in databases. Furthermore, additional augmentation to the input and output of information can be added without departing from the spirit and scope of the described invention. Finally, only a limited number of dimensions are explained and used for reordering of questions. More dimensions can be added as necessary without changing the scope of this invention.

Although the present invention has been discussed in considerable detail with reference to certain preferred embodiments, other embodiments are possible. Therefore, the scope of the appended claims should not be limited to the description of preferred embodiments contained in this disclosure. All references cited herein are incorporated by reference in their entirety.

What is claimed is:

1. An automated computer based system for assisting an individual in remembering and recounting information about a prior event using a cognitive interview and natural language processing, the system comprising:
a) a computer generated interactive user interface;
b) an adjustable interview component operably connected to the interactive user interface component comprising an interview algorithm, where the interview algorithm provides multiple instructions and open-ended questions according to the principles of a cognitive interview without a human interviewer;
c) a natural language processor operably connected to the interview component comprising a text processing algorithm, where the text processing algorithm interprets user input in natural language; and
d) a storage component operably connected to the natural language processor.

2. The system of claim 1, where the interactive user interface component is configured to provide questions based on cognitive interview principles to an interviewee, an interviewer, or both the interviewee and the interviewer.

3. The system of claim 1, where the computer generated interactive user interface component further comprises a voice recognition processor for receiving input from an interviewee, providing output to the interviewee or both receiving input and providing output to an interviewee.

4. The system of claim 1, where the computer generated interactive user interface component further comprises audio-visual aids to aid the interviewee in answering the questions.

5. The system of claim 1, where interview component is configured to influence the mood of the interviewee, pose appropriate questions to the interviewee, process answers given by the interviewee, store the answers given by the interviewee in a structured format, and provide feedback to the interviewee on information previously stored in the system via the interactive user interface.

6. The system of claim 1, where the interview component is configured to change questioning tactics using input received from the interviewee.

7. The system of claim 1, where the interview component is configured to transmit questions to the interface component in an order determined by principles of the cognitive interview.

8. The system of claim 1, where the natural language processor comprises:
a) a tokenizer operably connected to the natural language processor for delineating tokens, words, or both tokens and words;
b) a sentence splitter operably connected to the natural language processor for delineating individual sentences;
c) a parts-of-speech tagger operably connected to the natural language processor for combining the tokens, words and sentences with a linguistics lexicon and a set of linguistic rules and an assigned part-of-speech to teach work;
d) a chunker operably connected to the natural language processor for tagging verb phrases, noun phrases and other types of word chunks based on the users native language; and
e) a disambiguator for determining the intended meaning of a word or phrase by examining the linguistic context in which the word or phrase is used.

9. The system of claim 1, where the storage component further comprises a timestamp.

10. The system of claim 1, where the storage component comprises a first storage area for storing an original narrative text, a second storage area for storing information extracted from the narrative text, a third storage area for storing a listing of topics and items, a fourth storage area for storing answers obtained by the system, where the answers are stored with information about topics and items used by the system.

11. The system of claim 1 further comprising a scoring component operably connected to the natural language processor and the storage component for scoring the answers given by the interviewee based on dimensions of interest provided by the interviewer.

12. The system of claim 11, where the dimensions of interest in the scoring component comprise a general order, detail level of information, difficulty of information, stress levels of the interviewee, importance of the questions asked, time taken to answer the questions asked, random, interviewee preference, interviewer preference, relevance, quality of previous information, availability of information from other sources, quality of information from other sources, time, sensitivity of information, reference point, and previously provided information.

13. A method of assisting an individual in remembering and recounting information about a prior event using a cognitive interview and natural language processing, the method comprising the steps of:
a) providing the system of claim 1;
b) setting an interview level;
c) performing a first open-ended narrative interview according to the principles of the cognitive interview to provide information regarding an event;
d) recording the information using natural language;
e) conducting an interactive process of follow-up questions and answers after the first narrative has been received without a human interviewer, where the follow-up questions are adjusted for stress, details, level of importance and difficulty dimensions by the principles of the cognitive interview;
f) processing one or more narratives using natural language processing techniques;
g) performing entity extraction from the one or more narratives to identify information entities of interest;
h) storing the extracted information and the one or more narratives in a structured format; and
i) time stamping the stored information.

14. The method of claim 13, further comprising the steps of:
a) prior to the first narrative, informing an interviewee using an interface component of the system's purpose and the procedure that is followed;
b) reassuring the interviewee about the importance of the task, usefulness of the information, and importance of including all details;
c) explaining the interface component and special functions; and
d) including initial questions, not specified as part of the cognitive interview, for adjusting the interviewee's stress levels during the interview.

15. The method of claim 13, where the questions asked and answered in the one or more narratives are tracked and stored.

16. The method of claim 13, where an amount and a quality of information in the one or more narratives is tracked and stored.

17. The method of claim 13, where an order of topics and the questions asked are adjusted depending on the ongoing interaction and cognitive interview principles.

18. The method of claim 13, where an order of topics and the questions asked are adjusted depending on a difference in answers to similar questions that are tracked during the interview.

19. The method of claim 13, where the questions asked are adjusted based on how much stress a previous question caused, how information was remembered about the event by the user, the importance placed on the previous question by the user, and how far in the past that the event occurred.

20. The method of claim 13, where the questions asked can be repeated and a set number of attempts to get information from the interviewee on a specific detail is pre-set.

21. The method of claim 13, where the questions asked to the interviewee are scored on dimensions of interest.

22. The method of claim 21, where the dimensions of interest are selected from the group consisting of a general order, detail level of information, difficulty of information, stress levels of the interviewee, importance of the questions asked, time taken to answer the questions asked, random, interviewee preference, interviewer preference, relevance, quality of previous Information, availability of information from other sources, quality of information from other sources, time, sensitivity of information, reference point, and previously provided information.

23. The method of claim 21, where the dimensions of interest score alters the ordering of questions and topics during the interview.

24. The method of claim 13, where the questions asked are adjusted by one or more dimensions.

25. The method of claim 13, where the questions asked are grouped into one or more topics and all questions in a topic are asked and answered before beginning a new topic to minimize the number of switches between topics.

26. The method of claim 23, where the questions are generated for all topics that require information.

27. The method of claim 23, where the topic order is adjusted using a detail-level, a difficulty-level, an importance level, and a dimension.
